(19) United States
(12) Patent Application Publication
(10) Pub. No.: US 2010/0024968 A1
(43) Pub. Date: Feb. 4, 2010

(54) ADHESIVE INSTALLATION TOOL

(75) Inventors: John H. Vontell, Manchester, CT (US); Ronald W. Brush, Ringwood, NJ (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: UNITED TECHNOLOGIES CORPORATION, Hartford, CT (US)

(21) Appl. No.: 12/182,840

(22) Filed: Jul. 30, 2008

(51) Int. Cl. B29C 65/52

(52) U.S. Cl. 156/239; 156/538

(57) ABSTRACT

A tool includes a body, a first cavity, a first porous top cover, and a first vacuum port. The first cavity is located on a first side of the body. The first porous top cover extends across the first cavity. A tool guide may attach to the body to align the tool with a component.

### STATEMENT OF GOVERNMENT INTEREST

The U.S. Government has a paid-up license in this invention and the right in limited circumstances to require the patent owner to license others on reasonable terms as provided for by the terms of N00019-02-C-3003 awarded by the U.S. Navy.

### BACKGROUND

Gas turbine engines consist of many discrete components that are joined together to form a working system. Components may be joined together by various means such as welding, fastening, and bonding with adhesives. Commonly assigned U.S. application Ser. No. 11/494,830, which is incorporated by reference, discloses a removable adhesive developed specifically for bonding gas turbine components, such as electro thermal fan inlet case modular components. Removable adhesives are particularly advantageous in this context because they facilitate maintenance and repair work.

Adhesives are notoriously difficult to apply because characteristics that are beneficial to bonding are often problematic for installation. For example, a high tack adhesive may form a strong bond, but requires correct placement the first time, leaving no room for error. Likewise, while a thin low-modulus film of adhesive may be desirable from an engineering standpoint, such an adhesive will easily deform and be difficult to handle in production. Adhesives occupy an important niche for bonding gas turbine engine components, but known adhesive applicators are inadequate for this manufacturing context.

### SUMMARY

An exemplary embodiment of the present invention is a tool including a body, a first cavity, a first porous top cover, and a first vacuum port. The first cavity is located on a first side of the body. The first porous top cover extends across the first cavity. The vacuum port is connected to the first cavity.

Another exemplary embodiment of the present invention is a method for using a tool with an adhesive sheet. The adhesive sheet includes an adhesive layer disposed between a first release film and a second release film. The method includes placing at least one adhesive sheet on a tool, wherein the second release film faces the tool, applying a vacuum to the tool to hold the second release film in contact with the tool, removing the first release film to expose the adhesive layer, positioning the tool adjacent a component, pressing the adhesive layer against a surface of the component, and releasing the second release film from the tool.

### BRIEF DESCRIPTION OF THE DRAWINGS

FIG. 1A is a schematic top-view of an adhesive installation tool having a porous top cover.

FIG. 1B is a schematic top-view of an adhesive installation tool with the porous top cover removed.

FIG. 1C is a schematic side-view of FIG. 1A.

FIG. 2A is a schematic view of an adhesive sheet.

FIG. 2B is a schematic view of an adhesive installation tool and an adhesive sheet.

FIG. 2C is a schematic view of an adhesive installation tool and an adhesive sheet with a first release film removed to expose the adhesive layer.

FIG. 2D is a schematic side-view of an adhesive installation tool applying an adhesive layer to a component.

FIG. 2E is a schematic cross-section of FIG. 2D.

FIG. 2F is a schematic cross-section of an adhesive layer applied to a component with adhesive installation tool removed.

FIG. 2G is a schematic cross-section of an adhesive layer applied to a component with the second release film removed.

FIG. 2H is a schematic cross-section of an adhesive layer holding two components together.

FIG. 3 is a perspective view of a fan inlet case.

FIG. 4A is a plan view of an adhesive installation tool and an adhesive installation guide.

FIG. 4B is a plan view of an adhesive installation tool with an adhesive installation guide attached.

### DETAILED DESCRIPTION

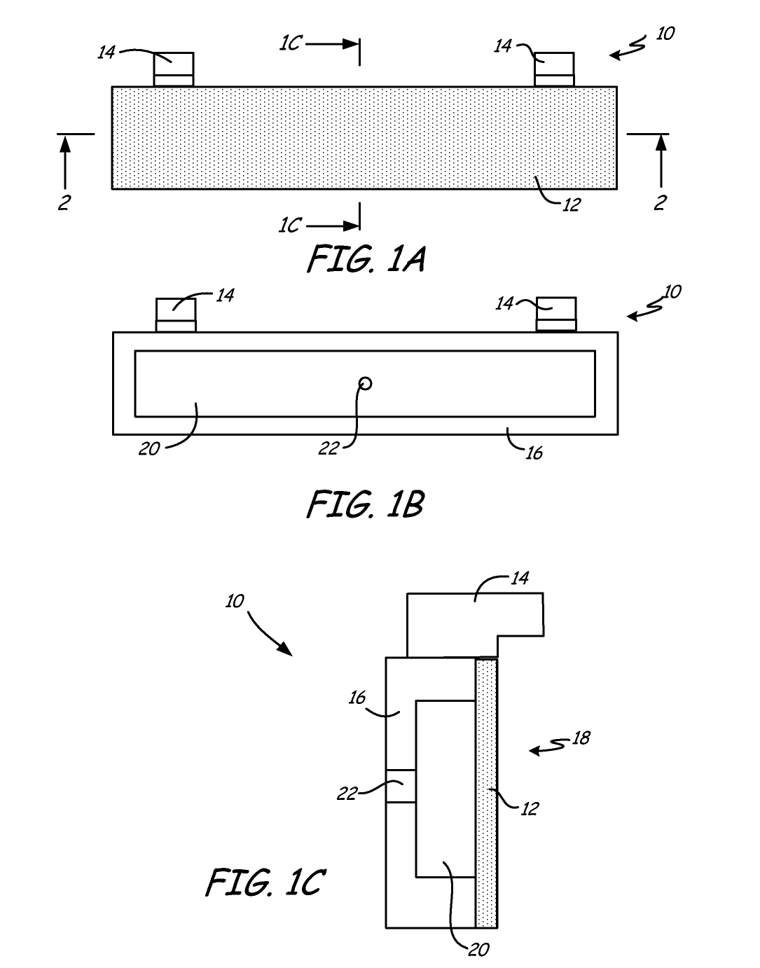

FIGS. 1A-1C depict adhesive installation tool 10. FIG. 1A is a schematic top-view of tool 10 including porous top cover 12 and tool guide 14. FIG. 1B is a schematic top-view of tool 10 with porous top cover 12 removed. FIG. 1C is a schematic side-view of FIG. 1A. Tool 10 has porous top cover 12 and tool guide 14, which are both situated on tool body 16. Also visible are first side 18 of tool body, cavity 20, and vacuum port 22.

Tool guide 14 is attached to generally rectangular body 16 and extends into space beyond first side 18. Cavity 20 lies within body 16 and opens to first side 18. Porous top cover 12 extends across cavity 20 and forms at least a portion of first side 18. Cavity 20 is connected to vacuum port 22. Vacuum port 22 allows inner cavity 20 to be attached to a vacuum source. In use, a vacuum source reduces pressure within inner cavity 20 via vacuum port 22. When pressure is reduced, an adhesive sheet may be held against, and supported by, porous top cover 12. Tool guide 14 extends beyond first side 18 in order to properly align tool 10 with a component surface. Tool 10 uses a combination of reduced pressure in cavity 20 together with tool guide 14 to repeatedly and accurately align an adhesive sheet with a component surface.

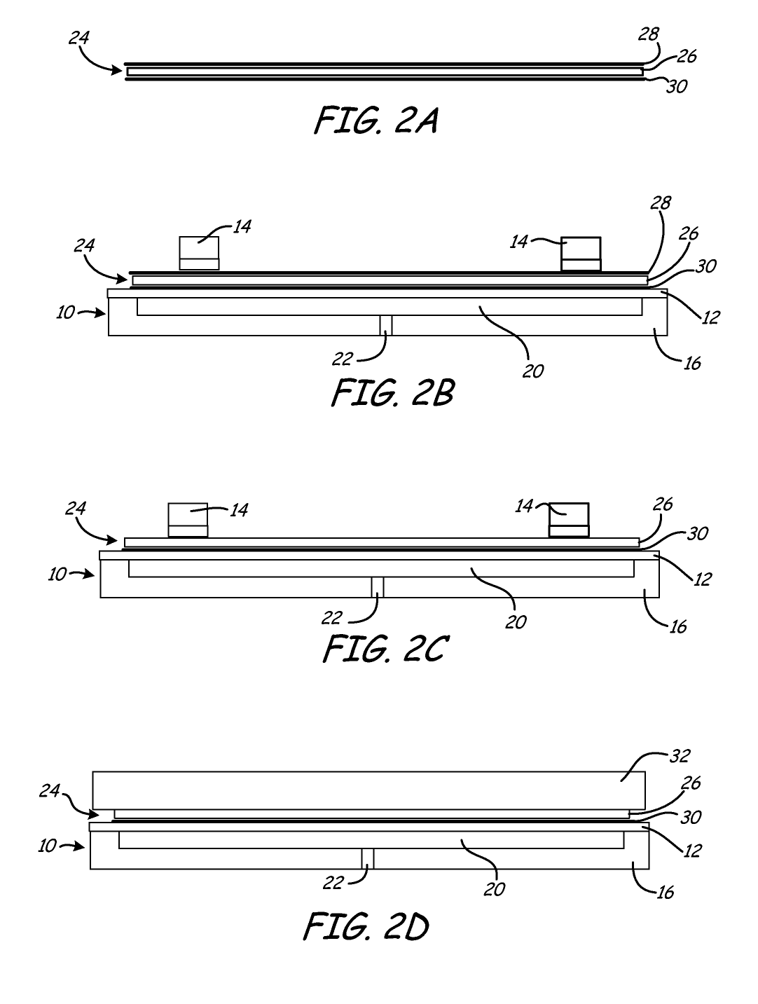

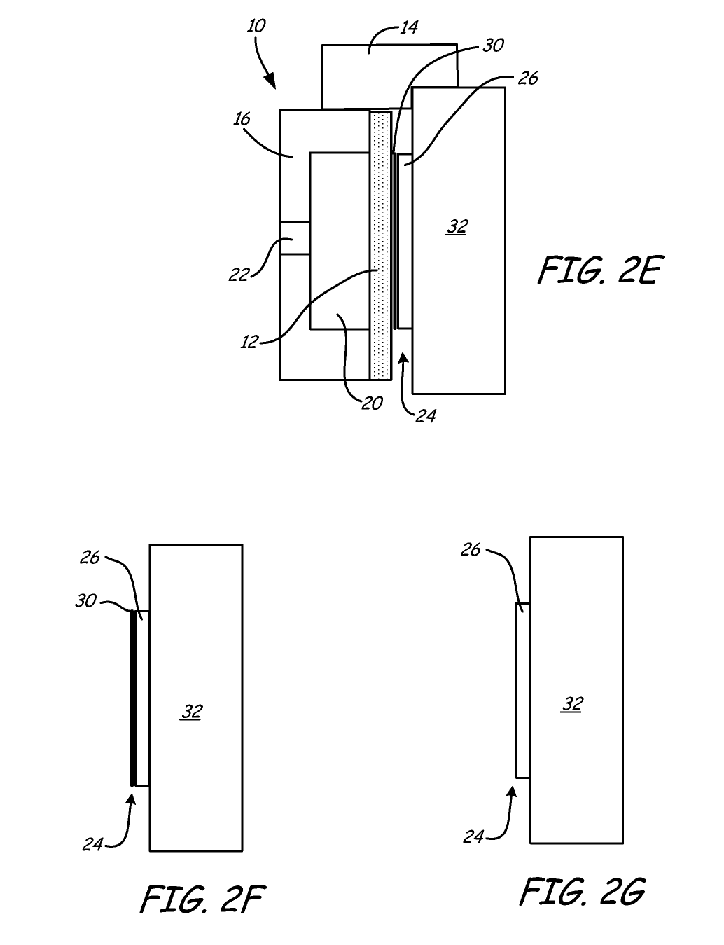

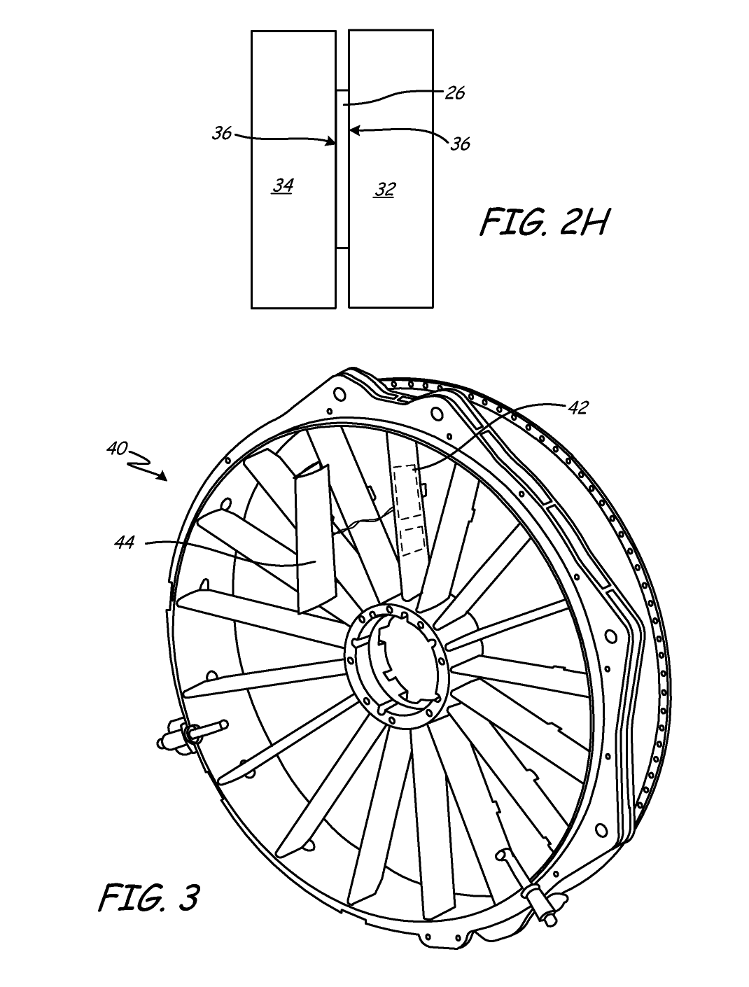

FIGS. 2A-2H depict how the adhesive installation tool 10 may be used to apply adhesive sheet 24 to a component. FIG. 2A is a schematic view of adhesive sheet 24, which includes adhesive layer 26, first release film 28, and second release film 30. Adhesive layer 26 is disposed between first release film 28 and second release film 30. Adhesive layer 26 may be a thin uncured adhesive, such as the removable adhesive disclosed in commonly assigned U.S. patent application Ser. No. 11/494,830. Adhesive layer 26 may be approximately 0.015 inches (0.0381 cm) thick, have low modulus and high tack.

FIG. 2B is a schematic view along section 2-2 of FIG. 1A of adhesive sheet 24 on tool 10. Adhesive sheet 24 may be placed on tool 10 so that second release film 30 faces porous top cover 12. If a vacuum source is connected to vacuum port 22, pressure within cavity 20 will be reduced. When pressure is reduced, second release film 30 is held against, and supported by, porous top cover 12. In this supported position, first release film 28 may be easily removed from adhesive sheet 24, thereby exposing adhesive layer 26 for installation.

FIG. 2C is a schematic view of adhesive installation tool 10 and adhesive sheet 24 with first release film 28 removed to expose adhesive layer 26. First release film 28 is easily removable when adhesive sheet 24 is supported by the reduced pressure installation tool 10. Exposed adhesive layer 26 is ready to be applied to a component.

FIG. 2D is a side-view of adhesive installation tool 10 applying exposed adhesive layer 26 to first component 32. FIG. 2E is a schematic cross-section of the same along section 1C-1C of FIG. 1A. After adhesive layer 26 is exposed, it is ready to be applied to first component 32. A user or robot may hold tool 10 and press exposed adhesive layer 26 onto a surface of first component 32. Tool guide 14 aids in aligning exposed adhesive layer 26 with a predetermined location on first component 32. Once adhesive layer 26 is applied, the vacuum source is removed from vacuum port 22. Pressure within cavity 20 will equalize and second release film 30 will be released from tool 10.

FIG. 2F shows adhesive sheet 24 applied to first component 32. Use of tool 10 is complete. Adhesive layer 26 is adhering to first component 32 and is supported thereby, allowing for removal of second release film 30. FIG. 2G shows adhesive layer 26 applied to first component 32 after second release film 30 has been removed. A second surface of adhesive layer 26 is exposed and ready to receive another component. FIG. 2H is a schematic side-view of adhesive layer 26 adhering components 32 and 34 together. First surface 36 of adhesive layer 26 is adhered to first component 32 and second surface 38 of adhesive layer 26 is adhered to second component 34. Adhesive layer 26 was accurately and reproducibly put in place by tool 10.

FIGS. 2A-2H also depict a method for using adhesive installation tool 10. The method includes placing adhesive sheet 24 on tool 10 with second release film 30 facing porous top cover 12, applying a vacuum to tool 10 to hold second release film 30 in contact with porous top cover 12, removing first release film 28 to expose adhesive layer 26, positioning tool 10 adjacent a first component 32, pressing adhesive layer 26 against component 32, and removing the vacuum source to release second release film 30 from tool 10. Second release film 30 may be safely removed once adhesive layer 26 is securely adhered to a first component 32. Methods of using adhesive installation tool 10 may benefit from use of tool guide 14 which aids in aligning adhesive sheet 24 with predetermined locations on first component 32. Also, methods of using tool 10 may benefit from placing an adhesive installation guide on tool 10 prior to placing adhesive sheet 24 on tool 10 and removing an adhesive installation guide from tool 10 prior to positioning tool 10 adjacent component surface 46. Adhesive installation guides are better illustrated in the context of a particular component and tool.

In order to further describe a specific application of the adhesive installation tool, an exemplary gas turbine engine component is depicted in FIG. 3. FIG. 3 is a perspective view of fan inlet case 40, which includes fan inlet case strut 42 and fan inlet shroud fairing 44. Fan inlet shroud fairing 44 is U-shaped and slides over fan inlet case strut 42. Phantom lines on strut 42 depict a possible location for installation of adhesives. Fan inlet shroud fairing 44 and strut 42 are exemplary gas turbine engine components on which use of an adhesive installation tool may be advantageous.

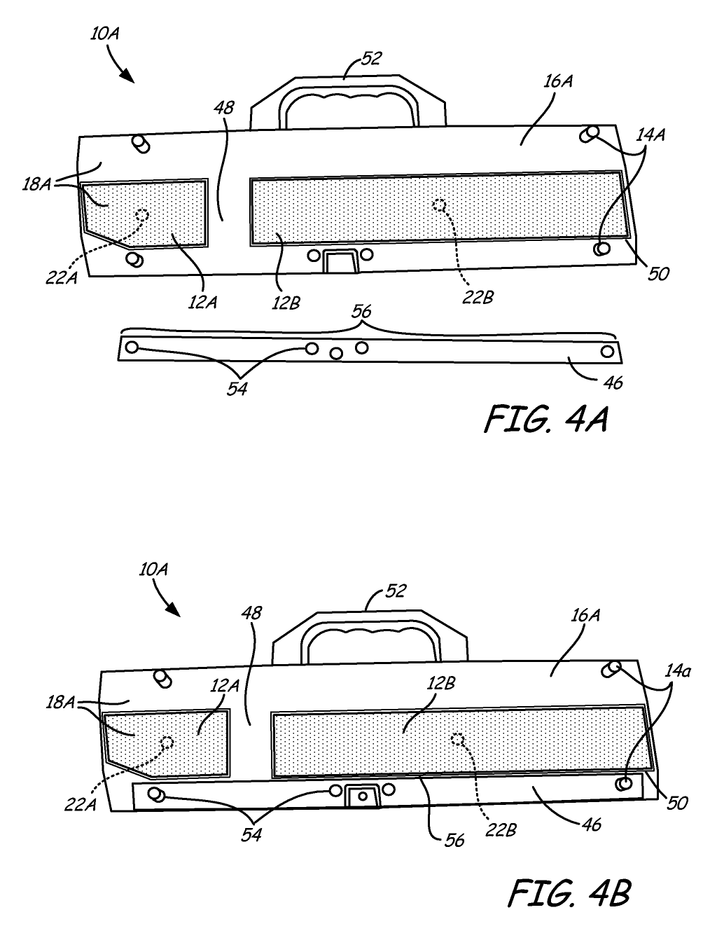

FIG. 4A is a plan view of adhesive installation tool 10A and adhesive installation guide 46, configured to apply an adhesive sheet to a fan inlet case strut. FIG. 4B is a plan view of adhesive installation tool 10A with adhesive installation guide 46 attached. Tool 10A includes first porous top cover 12A, second porous top cover 12B, and tool guide 14A, which are attached to tool body 16A. Tool body 16A also includes first side 18A, outer perimeter 48, adhesive locater lines 50, and handle 52. First vacuum port 22A is located behind first porous top cover 12A, and second vacuum port 22B is located behind second porous top cover 12B. Adhesive installation guide 46 is generally rectangular, has through holes 54, and surface 56.

Body 16A may be approximately rectangular having a length of about 15.8 inches (40.132 cm), a width of about 4.3 inches (10.922 cm) and a depth of about 0.5 inches (1.27 cm). Body 16A has first side 18A, which includes first and second porous top covers 12A, 12B and outer perimeter 48. First and second porous top covers 12A, 12B extend across their respective inner cavities (such as inner cavity 20 of FIG. 1) and form a first portion of first side 18A. Outer perimeter 48 surrounds first and second top covers 12A, 12B and forms a second portion of first side 18A. Located behind first and second porous top covers 12A, 12B and connected to their respective inner cavities, are first and second vacuum ports 22A, 22B. Tool guide 14A may be in form of pins attached to body 16A and extending beyond first side 18A. The location of tool guide 14A will depend on the component to which an adhesive sheet is being applied. For example, there may be a plurality of tool guides 14A located anywhere from about 4 inches (10.16 cm) apart to about 10.5 inches (26.67 cm) apart.

A plurality of adhesive locater lines 50 may be located on outer perimeter 48 adjacent first and second porous top covers 12A, 12B. Adhesive locater lines 50 may be etched into or drawn upon outer perimeter 48 and are configured to aid in accurate placement of adhesive sheets onto porous top covers 12A, 12B. If desired, handle 52 may be attached anywhere to body 48 to ease maneuvering of tool 10A. Adhesive installation guide 46 is removably attachable to outer perimeter 48 via holes 54 which are configured to receive tool locater pins 14A. When adhesive installation guide 46 is attached to outer perimeter 48 via holes 54, surface 56 is adjacent first and second porous top covers 12A, 12B.

The components of tool 10A operate as described above in reference to FIGS. 1 and 2. In use, adhesive installation guide 46 is placed on outer perimeter 48 so that holes 54 receive tool locater pins 14A. Adhesive sheet may use surface 56 as a placement guide, in that an edge of an adhesive film may abut surface 56 thereby placing the adhesive sheet in the desired location on first side 18A. Additionally, adhesive locater lines 50 located on outer perimeter 48 surrounding first and second porous top covers 12A, 12B serve as adhesive film placement guides. Once a vacuum source is applied to tool 10A, the adhesive sheets will be held against first and second porous top covers 12A, 12B and therefore, adhesive installation guide 46 may be removed.

Tool 10A may be metal, such as aluminum, or plastic. First and second porous top covers 12A, 12B are depicted in FIGS. 4A and 4B, but the number and shape of porous top covers may vary according to the desired area of adhesive installation. It is also appreciated that first side 18A including first and second porous top covers 12A, 12B may be flat, concave, or convex depending on the configuration of the component to which the adhesive is being applied.

While the invention has been described with reference to exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A tool comprising:
a body;
a first cavity on a first side of the body;
a first porous cover extending across the first cavity; and
a first vacuum port connected to the first cavity.

2. The tool of claim 1, further comprising:
at least one tool guide attached to the body to align the tool.

3. The tool of claim 2, wherein the tool guide comprises a plurality of pins.

4. The tool of claim 3, wherein the pins extend beyond the first side and are configured to align with a component.

5. The tool of claim 4, wherein the component is a fan inlet case strut.

6. The tool of claim 1, further comprising:
adhesive locater lines on an outer perimeter of the body adjacent the first porous top cover.

7. The tool of claim 6, further comprising:
an adhesive installation guide removably attachable to the outer perimeter.

8. The tool of claim 1, further comprising:
a handle attached to the body.

9. The tool of claim 1, wherein the first side is generally flat.

10. The tool of claim 1, wherein the body comprises at least one of metal and plastic.

11. The tool of claim 1, further comprising:
a second cavity on the first side of the body;
a second porous cover extending across the second cavity; and
a second vacuum port connected to the second cavity.

12. The tool of claim 12, further comprising:
an outer perimeter surrounding both the first porous top cover and the second porous top cover;
a plurality of adhesive locater lines located on the outer perimeter;
an adhesive installation guide removably attachable to the outer perimeter; and
a plurality of tool guide pins attached to the outer perimeter and extending beyond the first side, the tool locater pins configured to align the first side with a fan inlet case strut.

13. A method comprising:
placing at least one adhesive sheet on a tool, the adhesive sheet comprising an adhesive layer disposed between a first release film and second release film, wherein the second release film faces the tool;
applying a vacuum to the tool to hold the second release film in contact with the tool;
removing the first release film to expose the adhesive layer;
positioning the tool adjacent a component;
pressing the adhesive layer against a surface of the component; and
releasing the second release film from the tool.

14. The method of claim 13, further comprising:
verifying alignment of the tool and the component with at least one tool guide.

15. The method of claim 13, further comprising:
removing the second release film.

16. The method of claim 13, further comprising:
placing an adhesive installation guide on the tool; and
removing an adhesive installation guide from the tool.

17. The method of claim 13, wherein the component is a fan inlet case strut.

18. The method of claim 17, further comprising:
placing an adhesive installation guide on the tool prior to placing at least one adhesive sheet on the tool; and
removing an adhesive installation guide from the tool after placing at least one adhesive sheet on the tool.

19. The method of claim 18, further comprising:
verifying alignment of the tool and the component with at least one tool guide prior to pressing the adhesive layer against a surface of the fan inlet case strut.

20. The method of claim 19, further comprising:
removing the second release film after releasing the second release film from the tool.
